(19) United States
(12) Patent Application Publication
(10) Pub. No.: US 2020/0223354 A1
(43) Pub. Date: Jul. 16, 2020

(54) LED SAFETY SIGN SYSTEM

(71) Applicant: Sok Bong YUN, Hwaseong-si (KR)

(72) Inventor: Sok Bong YUN, Hwaseong-si (KR)

(21) Appl. No.: 16/247,522

(22) Filed: Jan. 14, 2019

(51) Int. Cl. B60Q 1/52; G09F 21/04; B60Q 1/44; B60Q 1/26; G09F 9/302

(52) U.S. Cl. CPC B60Q 1/52; G09F 21/048; G09F 9/302; B60Q 1/268; B60Q 1/44

(57) ABSTRACT

The present invention relates to an LED safety sign system, and more particularly, to an LED safety sign system in which a transparent printed circuit board including an LED and a control box mounted with a shock-detecting sensor are connected to each other so that when a shock equal to or greater than a predetermined value is applied to the control box or an automobile accident occurs, the LED of the transparent LED safety sign board automatically emits light to cause a red-edged triangular safety sign body to be lit to display a warning sign, and thus an emergency situation is identified by a driver at a remote distance, thereby preventing additional accident risks.

### BACKGROUND OF THE INVENTION

### 1. Field of the Invention

The present invention relates to an LED safety sign system, and more particularly, to an LED safety sign system in which a transparent printed circuit board including an LED and a control box mounted with a shock-detecting sensor are connected to each other so that when a shock equal to or greater than a predetermined value is applied to the control box or an automobile accident occurs, the LED of the transparent LED safety sign board automatically emits light to cause a red-edged triangular safety sign body to be lit to display a warning sign, and thus an emergency situation is identified by a driver at a remote distance, thereby preventing additional accident risk.

### 2. Description of Related Art

A case may occur in which a car is stopped due to a failure or an accident when traveling. In this case, when the stopped car is moved to an edge of a traveling road and then is parked at that point, or is stayed as it is at the traveling road to maintain a stopped state, a danger sign board that can alert other following drivers to such failure or accident is required to be erectly installed as a sign of caution.

A conventional danger sign board must be erectly installed artificially by a driver or another person who recognizes a danger of accident at a rear position of an accident vehicle, which is somewhat remote from an accident place to indicate an accident scene to prevent an additional accident, which acts as a hazard factor that causes further accident.

However, the conventional danger sign board entails a problem in that a case occurs in which a driver or a passenger cannot install a safety sign board used for alerting other drivers to an accident because he or she loses consciousness due to a head injury from a car crash, which makes it impossible to prevent an additional accident.

### SUMMARY OF THE INVENTION

The present invention has been made to solve the above-mentioned problems occurring in the safety sign board according to the prior art, and it is an object of the present invention to provide an LED safety sign system in which a transparent printed circuit board including an LED and a control box mounted with a shock-detecting sensor are connected to each other so that when a shock equal to or greater than a predetermined value is applied to the control box or an automobile accident occurs, the LED of the transparent LED safety sign board automatically emits light to cause a red-edged triangular safety sign body to be lit to display a warning sign, and thus an emergency situation is identified by a driver at a remote distance, thereby preventing additional accident risks.

To accomplish the above object, the present invention provides an LED safety sign system in which a transparent LED safety sign board is fixedly mounted to a side of an automobile rear windshield to provide convenience in driving without interruption of traveling of the automobile, in which when an automobile accident occurs, a shock-detecting sensor of a control box is operated to allow an LED of the transparent LED safety sign board to automatically emit light to cause a red-edged triangular safety sign body to be lit to display a warning sign, and thus an emergency situation such as an accident can be identified by a driver at a remote distance, and in which a driver or a passenger can install the safety sign board artificially, thereby preventing additional accident risks.

As described above, the LED safety sign system according to the present invention has the following advantageous effects.

An LED safety sign board is fixedly attached to a side of an automobile rear windshield and an LED of the safety sign board is lit to display a warning sign at the time of an impact or an accident, thereby avoiding accident risks caused by direct installation of the safety sign board on a road after movement of the safety sign board from an accident scene to another position by a driver. In addition, even in the case where a driver or a passenger is incapable of installing the safety sign board due to his or her unconsciousness immediately after an accident, an LED of the safety sign board is automatically lighted to display a warning sign in response to a vehicle impact to alert other drivers to the accident, thereby preventing additional accident risks.

Besides, the LED safety sign system according to the present invention enables an LED safety sign board to be fixedly mounted to a side of an automobile rear windshield and a control box to be fixedly mounted to the inside of an automobile trunk to provide convenience in driving without interruption of traveling of the automobile. In addition, when an automobile accident occurs, a shock-detecting sensor of the control box is operated to allow an LED and an LED assembly of the LED safety sign board to automatically emit light to cause a triangular safety sign body to be lit to display a warning sign, and thus an emergency situation such as an accident can be identified by a driver at a remote distance, and a driver or a passenger can install the safety sign board artificially, thereby preventing additional accident risks.

Further, the LED safety sign system according to the present invention separates a wiring of a PCB of a safety sign board to cause the LEDs of the safety sign board to emit red light in response to a shock sensed by the shock-detecting sensor, or to cause the control box 20 to supply power to the LEDs of the safety sign board in response to the operation of an automobile brake so that a horizontal rod-like sign board is lit simultaneously with a brake light, thereby providing stability of traveling of the automobile.

### BRIEF DESCRIPTION OF THE DRAWINGS

The above and other objects, features and advantages of the present invention will be apparent from the following detailed description of the preferred embodiments of the invention when taken in conjunction with the accompanying drawings, in which:

FIG. 1 is a perspective view showing a configuration of an LED safety sign system according to an embodiment of the present invention;

FIG. 2 is a front view showing a configuration of a control box of an LED safety sign system according to an embodiment of the present invention;

FIG. 3 is an exploded perspective view showing the control box shown in FIG. 2;

FIG. 4 is a diagrammatic view showing a state in which one transparent LED safety sign board is attached to a side of an automobile rear windshield according to an embodiment of the present invention;

FIG. 5 is a diagrammatic view showing a state in which two transparent LED safety sign boards are attached to a side of an automobile rear windshield according to an embodiment of the present invention;

FIG. 6 is a diagrammatic view showing a state in which a transparent LED safety sign boards is coupled to an automobile rear windshield by means of an adsorption plate according to an embodiment of the present invention;

FIG. 7 is a perspective view showing a state in which light is emitted from LEDs of a transparent LED safety sign board according to an embodiment of the present invention;

FIG. 8 is a perspective view showing a state in which LEDs of a transparent LED safety sign board are driven in a rod-like sign form when a brake is driven according to an embodiment of the present invention;

FIG. 9 is a perspective view showing a configuration of a LED safety sign system according to another embodiment of the present invention;

FIG. 10 is an exploded perspective view showing a configuration of a triangular LED safety sign board according to another embodiment of the present invention;

FIG. 11 is a diagrammatic view showing a state in which one transparent LED safety sign board is attached to a side of an automobile rear windshield according to another embodiment of the present invention;

FIG. 12 is a diagrammatic view showing a state in which two transparent LED safety sign boards are attached to a side of an automobile rear windshield according to another embodiment of the present invention;

FIG. 13 is a perspective view showing a state in which light is emitted from LEDs of a triangular transparent LED safety sign board according to another embodiment of the present invention;

FIG. 14 is a cross-sectional view showing a state in which light is emitted from LEDs of a transparent plastic body of the triangular transparent LED safety sign board shown in FIG. 9; and

FIG. 15 is a partial enlarged view showing a state in which light is emitted from an LED of a transparent plastic body of the triangular transparent LED safety sign board shown in FIG. 14.

### EXPLANATION ON SYMBOLS

1: automobile rear windshield
10: transparent LED safety sign board
11: transparent printed circuit board
12: LED (red)
20: control box
21: connection connector A
22: connection connector B
23: control box charge connector
24: brake light connector
25 power input connector
26: shock-detecting sensor
27: battery
28: control board
30: connection line
40: adsorption plate
50: triangular transparent LED safety sign board
51: triangular transparent plastic body
52: LED assembly
53: assembly connection line

### DETAILED DESCRIPTION OF THE PREFERRED EMBODIMENTS

Hereinafter, preferred embodiments of an LED safety sign system according to the present invention will be described in detail with reference to the accompanying drawings in order for a person of ordinary skill in the art to sufficiently understand and carry out the present invention.

The LED safety sign system of the present invention is configured such that a transparent LED safety sign board 10 is attached to a side of an inner surface of an automobile rear windshield 1 by means of an adsorption plate 40, and is connected to a control box 20 disposed within an automobile, e.g., an automobile trunk through a connection line 30 so that when a shock equal to or greater than a predetermined value applied to the control box 20 or an automobile accident occurs, an LED of the transparent LED safety sign board 10 is driven to emit light.

As shown in FIG. 1, the LED safety sign system according to the present invention largely includes a transparent LED safety sign board 10, a control box 20, a connection line 30, and an adsorption plate 40.

The transparent LED safety sign board 10 is configured such that a plurality of LEDs 12 are formed to have a safety sign pattern in a triangular shape having three edges on a transparent printed circuit board 11 so that the LEDs are operated to emit light to display a warning sign at the time of a shock or an accident.

The control box 20 includes a shock-detecting sensor 26 and is fixedly disposed at a side of an interior of an automobile, e.g., an automobile trunk so as to be connected to the transparent LED safety sign board 10 through a connection line 30 so that the shock-detecting sensor 26 detects a shock equal to or greater than a predetermined value stored therein or an automobile accident and transmits a corresponding signal to the transparent LED safety sign board 10 to cause an LED of the transparent LED safety sign board 10 to emit light to display a warning sign.

The adsorption plate 40 is disposed at each corner of the transparent LED safety sign board 10 formed in a rectangular shape so as to allow the transparent LED safety sign board 10 to be fixedly adsorbed to an automobile rear windshield 1.

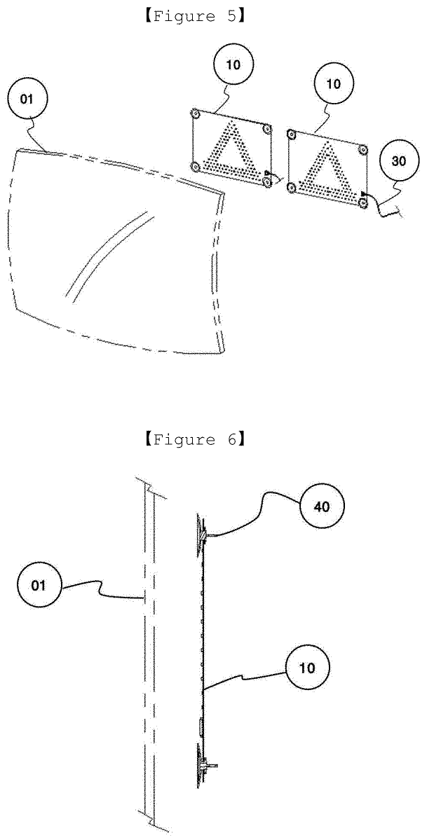

In other words, the adsorption plate 40 is disposed at each corner of the transparent LED safety sign board 10 as shown in FIG. 6 so that the transparent LED safety sign board 10 is fixedly adsorbed to a side of an inner surface of the automobile rear windshield 1 as shown in FIGS. 4 and 5.

In the meantime, the transparent printed circuit board 11 of the transparent LED safety sign board 10 is configured to have two wirings in such a manner to allow the LEDs of the transparent LED safety sign board 10 to emit light in the triangular safety sign pattern having three edges to display a warning sign in response to the drive of the shock-detecting sensor, or allow to be connected to an automobile brake light when the automobile travels to allow LEDs of a red horizontal rod to emit light to display a warning sign when a brake is operated.

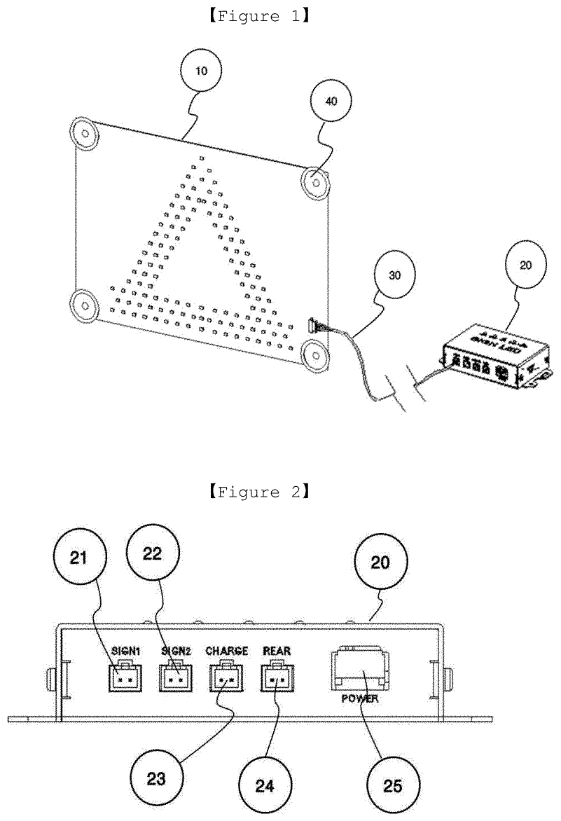

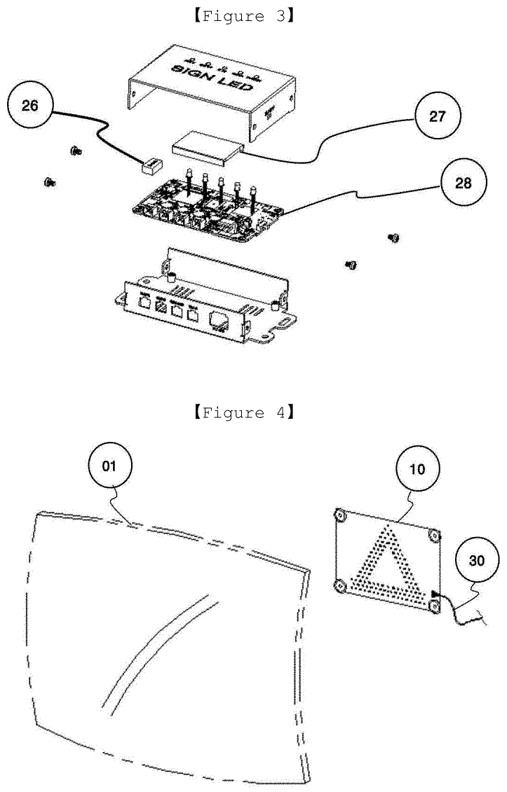

As shown in FIGS. 2 and 3, the control box 20 includes a connection connector A 21, a connection connector B 22, a charge connector 23, a brake light connector 24, a power input connector 25, a shock-detecting sensor 26, and a battery 27.

The connection connector A 21 allows the transparent LED safety sign board 10 and the control box 20 to be operated in cooperation with each other through the connection line 30 so that power is supplied to the LEDs 12 of the transparent LED safety sign board 10 through the battery 27.

In addition, as shown in FIG. 5, two transparent LED safety sign boards 10 can attached to a side of an inner surface of the automobile rear windshield 1. The connection connector B 22 allows the transparent LED safety sign board 10 and the control box 20 to be operated in cooperation with each other through the connection line 30 so that power is supplied to the LEDs 12 of the transparent LED safety sign board 10 through the battery 27.

The charge connector 23 is connected to the power input connector 25 to charge the battery 27 built in the control box 20 so that the charge connector 23 allows the LEDs 12 of the transparent LED safety sign board 10 emit light with the power of the battery 27 of the control box 20 when power is not supplied to the control box 20 due to an automobile accident, and the charge connector 23 allows the LEDs 12 of the transparent LED safety sign board 10 to be driven by being supplied with power through the power input connector 25 or by being supplied with the power charged in the battery 27 of the control box 20 upon the ordinary traveling or the stop of the automobile.

The shock-detecting sensor 26 is disposed at a side of a control board 28 in the control box 20 so that when a shock equal to or greater than a predetermined value is applied to the control box or an automobile accident occurs, the shock-detecting sensor 26 detects the shock to output a corresponding detection signal to allow the LEDs 12 or the LED assemblies 52 of the transparent LED safety sign board 10 or 50 to emit light in response to a control signal from an MCU (not shown) of the control box 20.

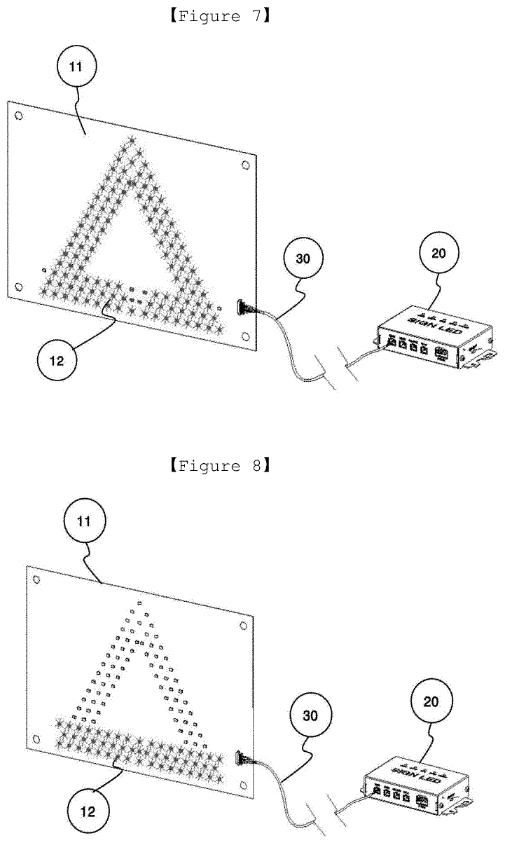

The transparent LED safety sign board 10 of the present invention selectively provides a safety sign pattern formed in a triangular shape having three edges or a safety sign pattern formed in a rod shape. As shown in FIGS. 7 and 8, the transparent LED safety sign board 10 is configured such that a wiring of the printed circuit board 11 is separated to cause the power to be supplied to the LEDs 12 of the triangular safety sign board to allow the LEDs 12 to emit red light in response to a shock sensed by the shock-detecting sensor 26 of the control box 20, or to cause the control box 20 to sense the operation of an automobile brake and supply the power to the LEDs 12 of the rod-shaped safety sign board to allow the LEDs 12 to emit light to display a warning sign.

In other words, the brake light connector 24 of the control box 20 is connected in parallel with a power source for an automobile brake light so that when the brake light is turned on in response to the drive of the automobile brake, the transparent LED safety sign board 10 and the safety sign board connection connector A 21 of the control box 20 are connected to each other by means of the connection line 30 to allow the power to be supplied to the LEDs 12 so that the red-colored horizontal rod sign board is lit simultaneously with the automobile brake light.

In addition, the battery 27 mounted on the control board 38 of the control box 20 allows the LED safety sign board 10 to continuously emit light through the power charged in the battery 27 although the power is not supplied to the control box 20 due to an automobile accident, and the control box 20 is supplied with power through the power input connector 25 upon the ordinary traveling or the stop of the automobile and the supplied power charges the battery 27 built in the control box 20.

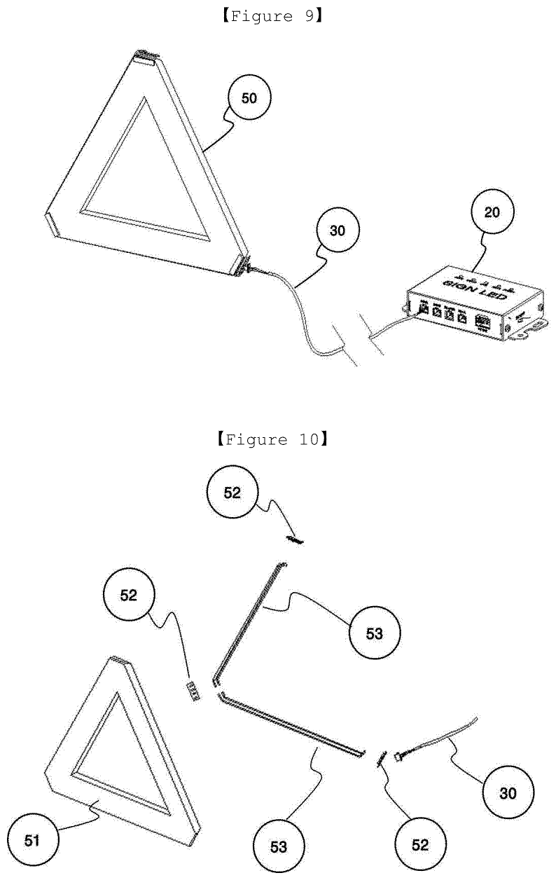

As shown in FIGS. 9 and 10, an LED safety sign system according to another embodiment of the present invention includes a triangular transparent LED safety sign board 50, a control box 20, and a connection line 30.

The triangular transparent LED safety sign board 50 includes a triangular transparent plastic body 51 and an LED assembly 52 attached to each corner of the triangular transparent plastic body 51 to form a triangular safety sign board. Red light is emitted from the LED assembly 52 through the triangular transparent plastic body 51 to operate the safety sign board. When a shock equal to or greater than a predetermined value is applied to the shock-detecting sensor built in the control box 20 or an automobile accident occurs, the triangular transparent LED safety sign board 50 and the safety sign board connection connector A 21 of the control box 20 are connected to each other by means of the connection line 30 to allow the power to be automatically supplied to the LED assemblies 52 so that the triangular sign board is lit automatically as shown in FIG. 13.

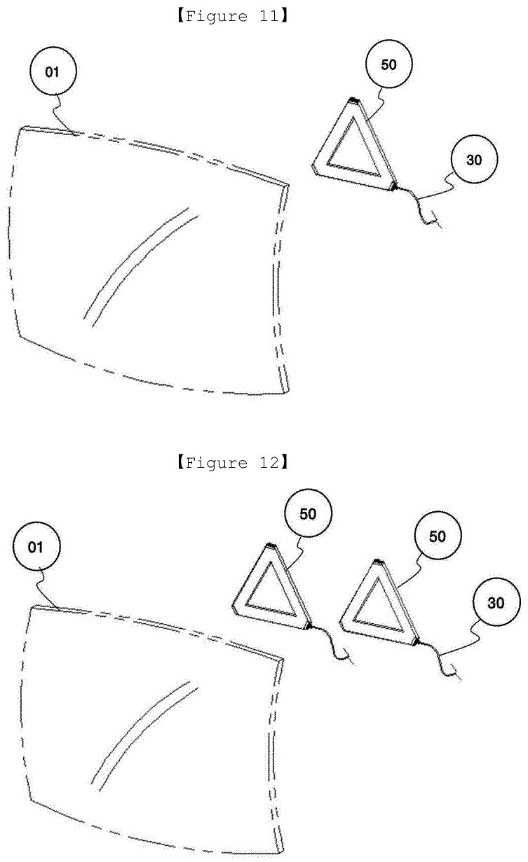

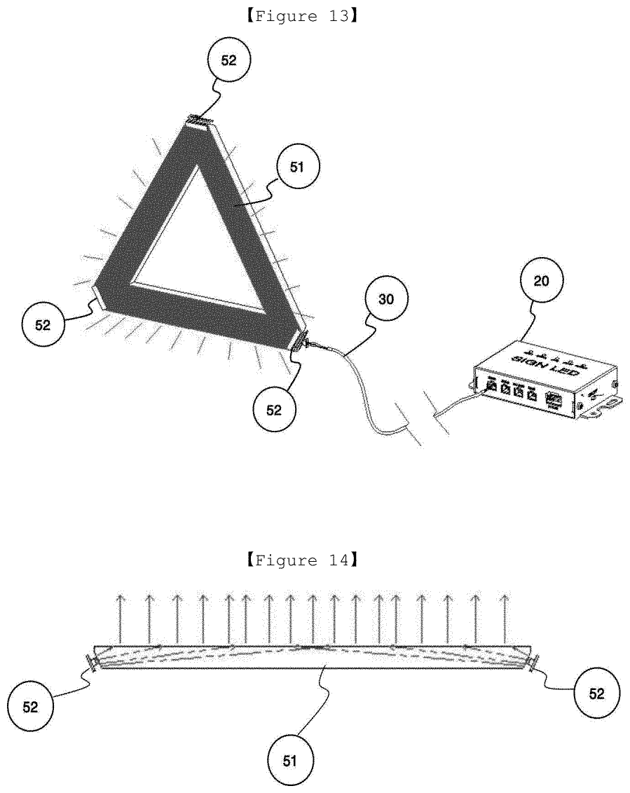

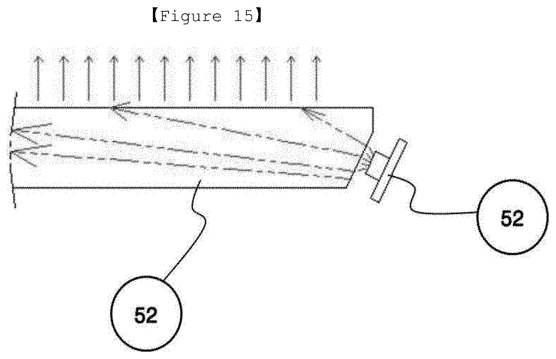

Meanwhile, the triangular transparent LED safety sign board 50 may be configured such that one triangular transparent LED safety sign board 50 is fixedly attached to a side of an inner surface of the automobile rear windshield 1 by means of a double-sided adhesive tape and the safety sign board and the connection connector A 21 of the control box 20 are interconnected to be operated in cooperation with each other through the connection line 30 as shown in FIG. 11, or two triangular transparent LED safety sign boards 50 are fixedly attached to a side of an inner surface of the automobile rear windshield 1 by means of a double-sided adhesive tape and the safety sign board and the connection connectors A 21 and B 22 of the control box 20 are interconnected to be operated in cooperation with each other through the connection line 30 as shown in FIG. 12.

The LED assembly 52 is attached to each of three corners of the triangular transparent plastic body 51 and power is supplied to each LED assembly 52 through an assembly connection line 53. Power is supplied to one of the LED assemblies 52 by interconnecting the safety sign board and the connection connector A 21 of the control box 20 through the connection line 30.

In the meantime, as shown in FIGS. 10 and 11, the triangular transparent LED safety sign board 50 allows LEDs of the LED assemblies 52 attached to three corners of the triangular transparent plastic body 51 to emit light so that the LED light passes through the triangular transparent plastic body 51 to cause the triangular transparent LED safety sign board 50 to be lit as shown in FIG. 13.

The LEDs 12 of the transparent printed circuit board 11 are formed to have a safety sign pattern in a triangular shape having three edges, and the three LED assemblies 52 of the triangular transparent plastic body 51 are configured to form a triangle. When power is not supplied to the LED assembly 52, the triangular LED safety sign board 50 is attached to the automobile rear windshield 1 in a transparent state so that a driver can view the rear situation of a vehicle when it travels on a road.

While the preferred embodiments of the present invention has been shown and described with reference to the accompanying drawings, they are merely illustrative embodiments, and the invention is not limited to these embodiments. It is to be understood by a person having an ordinary skill in the art that various equivalent modifications and variations of the embodiments can be made without departing from the spirit and scope of the present invention. Therefore, various embodiments of the present invention are merely for reference in defining the scope of the invention, and the true technical scope of the present invention should be defined by the technical spirit of the appended claims.

What is claimed is:

1. An LED safety sign system comprising:
a transparent LED safety sign board 10 configured such that one or more LEDs 12 are formed to have a safety sign pattern in a triangular shape having three edges on a transparent printed circuit board 11 so that the LEDs are operated to emit light to display a warning sign at the time of a shock or an accident;
a control box 20 including a shock-detecting sensor 26 and fixedly disposed at a side of an interior of an automobile, e.g., an automobile trunk so as to be connected to the transparent LED safety sign board 10 through a connection line 30 so that the shock-detecting sensor 26 detects a shock equal to or greater than a predetermined value stored therein or an automobile accident and transmits a corresponding signal to the transparent LED safety sign board 10 to cause the LEDs of the transparent LED safety sign board 10 to emit light to display a warning sign; and
an adsorption plate 4 disposed at each corner of the transparent LED safety sign board 10 formed in a rectangular shape so as to allow the transparent LED safety sign board 10 to be fixedly adsorbed to an automobile rear windshield 1.

2. An LED safety sign system comprising:
a triangular transparent LED safety sign board 50 including a triangular transparent plastic body 51 and an LED assembly 52 attached to each corner of the triangular transparent plastic body 51 to form a triangular safety sign board so that the LED assemblies 52 emit red light through the triangular transparent plastic body 51 at the time of an impact or an accident of a vehicle.
a control box 20 including a shock-detecting sensor 26 and fixedly disposed at a side of an interior of an automobile trunk so as to be connected to the transparent LED safety sign board 50 through a connection line 30 so that the shock-detecting sensor 26 detects a shock equal to or greater than a predetermined value stored therein or an automobile accident and transmits a corresponding signal to the triangular transparent LED safety sign board 50 to cause the LED assemblies 52 of the triangular transparent LED safety sign board 50 to emit light to display a warning sign.

3. The LED safety sign system according to claim 1, wherein the control box 20 comprises:
a connection connector A 21 configured to allow the transparent LED safety sign board 10 and the triangular transparent LED safety sign board 50 to be operated in cooperation with the control box 20 through the connection line 30, and allow power to be supplied to the LEDs 12 or the LED assemblies 52 of the transparent LED safety sign board 10 or 50;
a charge connector 23 connected to the power input connector 25 to charge the battery 27 built in the control box 20 so that the charge connector 23 allows the LEDs 12 or the LED assemblies 52 of the transparent LED safety sign board 10 or 50 emit light with the power of the battery 27 of the control box 20 when power is not supplied to the control box 20 due to an automobile accident, and the charge connector 23 allows the LEDs 12 or the LED assemblies 52 of the transparent LED safety sign board 10 or 50 to be driven by being supplied with power through the power input connector 25 upon the ordinary traveling or the stop of the automobile; and
a shock-detecting sensor 26 disposed at a side of a control board 28 in the control box 20 so that when a shock equal to or greater than a predetermined value is applied to the control box 20 or an automobile accident occurs, the shock-detecting sensor 26 detects the shock to output a corresponding detection signal to allow the LEDs 12 or the LED assemblies 52 of the transparent LED safety sign board 10 or 50 to emit light in response to a control signal from an MCU of the control box 20.

4. The LED safety sign system according to claim 3, wherein the control box 20 is configured such that a first transparent LED safety sign board 10 or triangular transparent LED safety sign board 50 is connected to the connection connector A 21 of the control box 20, a second transparent LED safety sign board 10 or triangular transparent LED safety sign board 50 is connected to a connection connector B 22 of the control box 20, and power is supplied to the LEDs 12 or the LED assemblies 52 of the safety sign board 10 or 52.

5. The LED safety sign system according to claim 1, wherein the transparent LED safety sign board 10 is configured such that a wiring of the printed circuit board 11 is separated to cause the LED 12 of the safety sign board to emit red light in response to a shock sensed by the shock-detecting sensor 26 of the control box 20, or to cause the control box 20 to sense the operation of an automobile brake and supply power to the LEDs 12 so that a horizontal rod-like sign board is lit simultaneously with a brake light.
